(19) United States
(12) Patent Application Publication
(10) Pub. No.: US 2004/0158558 A1
(43) Pub. Date: Aug. 12, 2004

(54) Information processor and program for implementing information processor

(76) Inventors: Atsuko Koizumi, Sagamihara (JP); Yasutsugu Morimoto, Kodaira (JP); Hiroyuki Kumai, Kunitachi (JP); Naoto Akira, Kokubunji (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/623,598

(22) Filed: Jul. 22, 2003

(30) Foreign Application Priority Data
Nov. 26, 2002 (JP) 2002-341671

(51) Int. Cl. G06F 7/00

(52) U.S. Cl. 707/3

(57) ABSTRACT

Disclosed is a text mining method with steps for separating high frequency information and low frequency information and applying an ideal analysis method to each kind of information. Negative expressions and modality expressions are extracted from the low frequency information to assist in extracting valuable knowledge for risk management. Text classification technology by the conventional key word method is suitable for extracting and classifying high frequency knowledge but extracting valuable information for risk management or from the actual customer voice in the call center text database requires extracting the essential valuable knowledge from vast quantities of ordinary information. This method has a function to hold in a folder the document found by a keyword search, and a function to store the remaining text into a low frequency information folder, after having stored the high frequency information found by keyword search. A function is also provided for extracting modality expressions that express negative expressions and modalities as a unit to extract valuable knowledge for risk management from low frequency information.

### BACKGROUND OF THE INVENTION

1. Field of the Invention

The present invention relates to a text mining method for extracting knowledge from text in natural language and is mainly used for analysis in the call center text database.

2. Description of Related Art

Text classification systems using keywords specified by the user, assist in classifying text, by detecting and displaying keywords as viewed from their lack of use (or keywords not used in a category) based on the frequency that the keyword appears in the text (See for example, patent document 1).

The unit for extracting valuable knowledge for risk management focuses on expressions such as “ [symbol] (rude)” or “ [symbol] (disappointment)”. In this method for extracting negative expressions, keywords having negative meanings such as “ [symbol] (lost order)” or “ [symbol] (complaint)” are preset according to their domain, a search made, and if a hit occurs an alert is issued. There are also text classification systems possessing unit allowing the user to rewrite a keyword dictionary for the text category (See for example, patent document 2).

| | |
|---|---|
| [Patent document 1] | JP-A No. 101226/2001 |
| [Patent document 2] | JP-A No. 184351/2001 |

Text classification technology of the related art is suitable for extracting and categorizing high-frequency knowledge. However, extracting valuable information for risk management and the actual voice of the customer from the call center text database by extracting low frequency knowledge is extremely important. In other words, it is important to efficiently and without omissions, extract the essential valuable knowledge from among a vast quantity of ordinary information. An object of the present invention is to create FAQ (frequently asked questions) based on a high frequency of inquiries and to extract valuable information for risk management from a low frequency (low number) of inquiries. Analyzing text (or text mining) for risk management uses the technique of extracting negative expressions. In the method for extracting negative expressions, keywords such as “rude” or “disappointment” are preset and a search made. However, this method has the problem that setting the keywords in advance requires much time and effort, covering all items is impossible and many omissions occur.

### SUMMARY OF THE INVENTION

To resolve the above mentioned problems of the related art, the text mining system of the present invention employs a method for extracting low frequency information having a function for extracting and storing high frequency information in a folder, and then gathering the remainder of the text and storing it in a low frequency information folder. The system of the present invention further has a unit to eliminate noise and omissions in the extraction of negative expressions from data in the low frequency information folder by extracting candidate negative words from the target text by utilizing a dictionary storing characters having negative meanings such as “ [symbol] (lose)” or “ [symbol] (negative)”, and after registering words determined to be negative words in the negative word dictionary, using this negative word dictionary to extract the negative expressions.

The present invention is capable of sorting information in the call center text database (hereafter, reply log) into high frequency information and low frequency information, rendering the effect that text mining methods can be applied to each type of information. Sorting the high frequency information into topics assists in creating FAQ. Information valuable for risk management can be extracted by viewing low frequency information in terms of negative expressions and modality expressions.

The negative expression extraction method of the present invention has the effect of preventing omissions during extraction by using characters as clues to extract candidate negative words contained in the target text for analysis (mining). The task of judging whether the candidate negative words that were extracted are negative words must be performed by human effort. However, words determined to be negative words are accumulated in the negative word dictionary and the stop word dictionary for extracting-negative-words so the invention renders the further effect that the number of candidate negative words are gradually narrowed down through the process of repetition.

### BRIEF DESCRIPTION OF THE DRAWINGS

FIG. 1 is a block diagram of the embodiment of the text mining system of the present invention;

FIG. 2 is a drawing showing the data structure of the call center text database;

FIG. 3 is a drawing showing the data structure of an association thesaurus storage section;

FIG. 4 is a drawing showing the data structure of a term vector storage section;

FIG. 5 is a drawing showing the data structure of a thesaurus overview storage section;

FIG. 6 is a drawing showing the data structure of a display interface for text classification;

FIG. 7 is a flow chart showing the procedure for generating data for thesaurus browsing;

FIG. 8 is a flow chart showing the procedure for thesaurus browsing;

FIG. 9 is a flow chart showing the text classification procedure;

FIG. 10 is a drawing showing the data structure of a text folder;

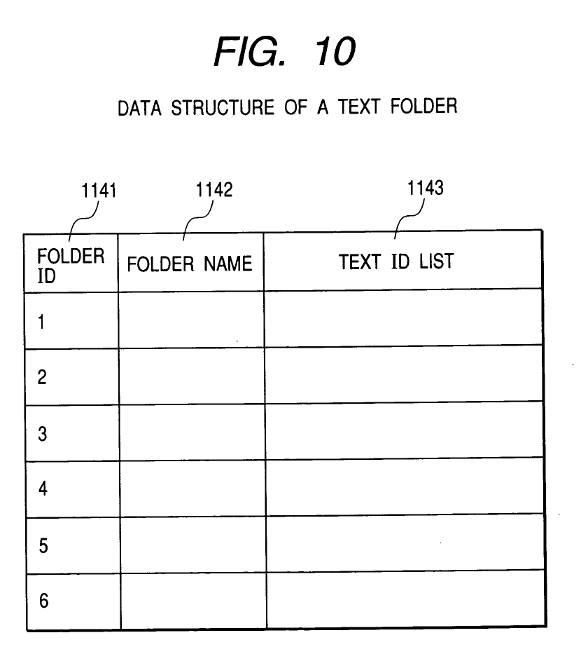

FIG. 11 is a drawing showing an example of a negative word identification screen;

FIG. 12 is a drawing showing the data structure of a negative character dictionary;

FIG. 13 is a drawing showing the data structure of a negative word dictionary;

FIG. 14 is a drawing showing the data structure of a stop word dictionary for extracting negative words;

FIG. 15 is a drawing showing the data structure of a modality expression dictionary;

FIG. 16 is a drawing showing the data structure of a stop word dictionary for extracting modality expressions;

FIG. 17 is a flow chart showing the procedure for extracting candidate negative words;

FIG. 18 is a flow chart showing the procedure for generating a negative word dictionary;

FIG. 19 is a flow chart showing the procedure for extracting modality expressions;

FIG. 20 is a flow chart showing the procedure for generating a modality expression dictionary; and

FIG. 21 is a flow chart showing the procedure for extracting negative expressions and modality expressions.

### DETAILED DESCRIPTION OF THE PREFERRED EMBODIMENTS

The embodiments of the present invention are described next. The embodiment of the invention is a text mining system for call center text databases. The embodiments are described in detail while referring to the accompanying drawings.

(System structure)

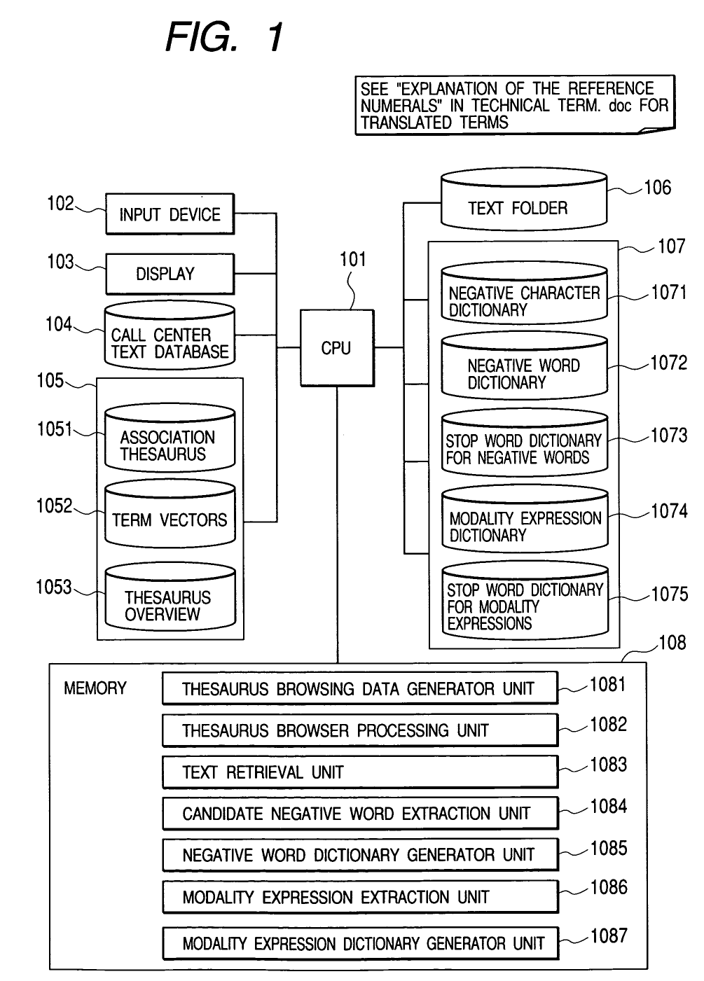

FIG. 1 is a block diagram of the first embodiment of the text mining system of the present invention. This system comprises a CPU 101, an input device 102, a display-103, a call center text database 104, a data storage section for thesaurus browsing 105, a text folder 106, a data storage section for extracting low frequency knowledge 107, and a memory 108. The data storage section for thesaurus browsing 105 comprises a storage section for association thesaurus 1051, a storage section for term vectors 1052, and a storage section for thesaurus overview 1053. The data storage section for extracting low frequency knowledge 107 comprises a negative character dictionary 1071 for implementing extraction of negative expressions, a negative word dictionary 1072, a stop word dictionary 1073 for extracting negative words, a modality expression dictionary 1074 for implementing extraction of modality expressions, and a stop word dictionary 1075 for extracting modality expressions. The memory 108 comprises a thesaurus browsing data generator unit 1081, a thesaurus browser processing unit 1082, a text retrieval unit 1083, a candidate negative word extraction unit 1084, a negative word dictionary generator unit 1085, a modality expression extraction unit 1086, and a modality expression dictionary generator unit 1087.

(Call Center Text Database)

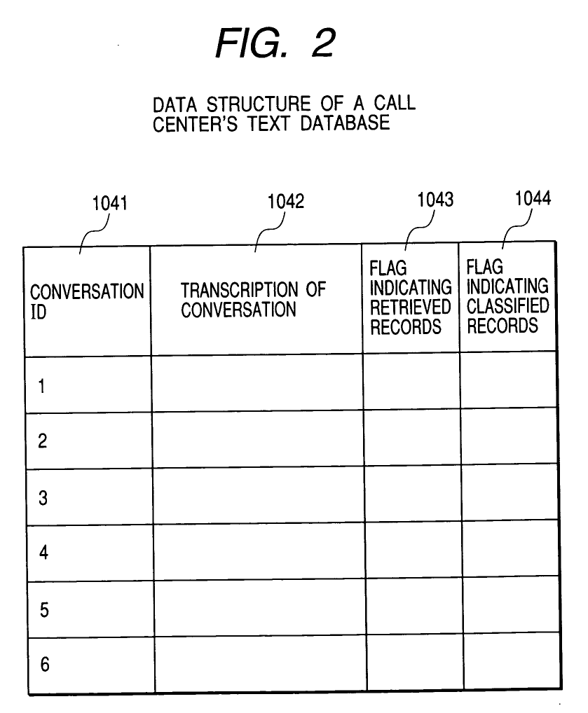

FIG. 2 is a drawing showing the data structure of the call center text database 104. A conversation (inquiry) ID 1041, a transcript of conversation 1042, a retrieval flag 1043 showing that keyword retrieval is complete, and a classifying flag 1044 showing that sorting into the classification folder is complete are recorded in each record of the call center database 104.

(Thesaurus Browsing Function)

The system of this invention contains a thesaurus browsing function to assist in extracting documents containing valuable information. Here, a thesaurus is a network expression showing distinctive (characteristic) words within a document collection and their relation. The thesaurus browsing function of this system comprises a function to automatically create a thesaurus from a document collection, and a function to show an overview and detailed view of the thesaurus (overall display-zoom display). The automatic creation of the thesaurus and the thesaurus display are implemented by the thesaurus browsing method disclosed for example in JP-A No. 227917/2000. The overall concept of the data and processing procedures for implementing the thesaurus browsing function of this system are described next. The data for implementing the thesaurus browsing function is first described. The thesaurus browsing data storage section 105 comprises an association thesaurus 1051, a term vector storage section 1052, and a thesaurus overview storage section 1053.

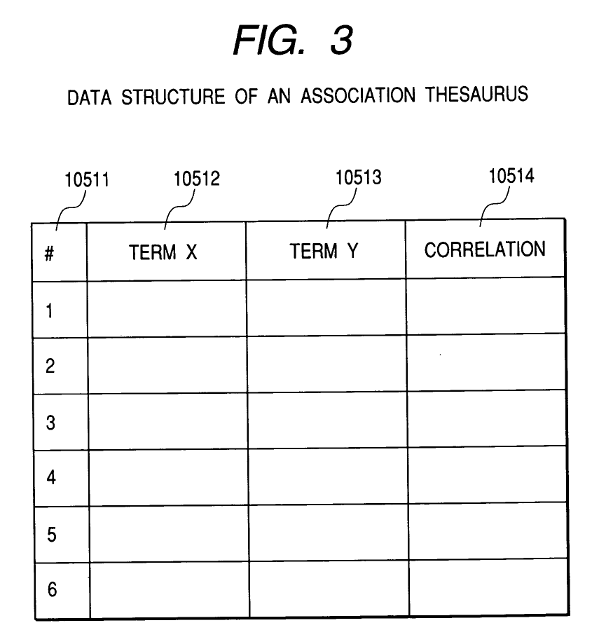

The association thesaurus created from document data in the transcript of conversation 1042 of call center text database 104 is stored in the association thesaurus 1051. The association thesaurus shows the relation between one word and another word. In this embodiment, the association level expresses how easily co-occurrence may happen in two words. The association level is based on the frequency at which each word occurs and the co-occurrence frequency (frequency at which the two words appear simultaneously within a certain range in the text). FIG. 3 shows the data structure of the association thesaurus 1051. The association thesaurus 1051 comprises a record ID 10511, a term X 10512, a term Y 10513, and an association level 10514. Related terms are stored in the term X 10512 and the term Y 10513, and their association level is stored in the association level 10514.

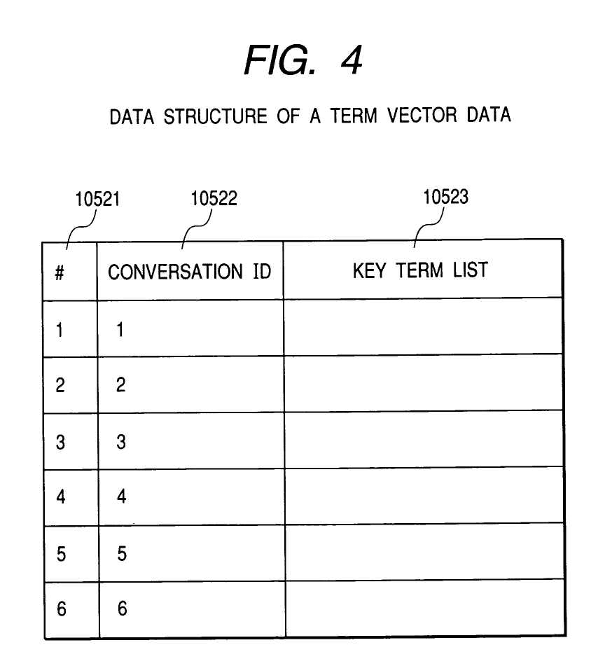

Term vectors extracted from document data stored in the transcript of conversation 1042 of call center database 104 are stored in the term vector storage section 1052. Here, term vectors are the numerical weight of terms in a document and can be extracted by utilizing the tr-idf method (Term Frequency Inverse Document Frequency) described in “Salton, G., et al.: A Vector Space Model for Automatic Indexing, Communications of the ACM, Vol. 18, No. 11 (1975). This tf-idf method is most well known at the text indexing method. In this method, a value found by multiplying the frequency that the subject term appears in a document (tf) by its inverse or inverse document frequency (idf) is set as the weight of the term in the target document and terms with a high weight (in other words, key terms) are extracted and set as the term vectors. FIG. 4 shows the data structure of the term vector storage section 1052. The term vector storage section 1052 comprises a record ID 10521, a conversation ID 10522 and a key term list 10523. An ID for the text log (response log) stored in the call center text database 104 is stored in the record ID 10521. A list of high-weighted (important) terms appearing in transcript of conversation of the applicable text log are stored in the key term list 10522.

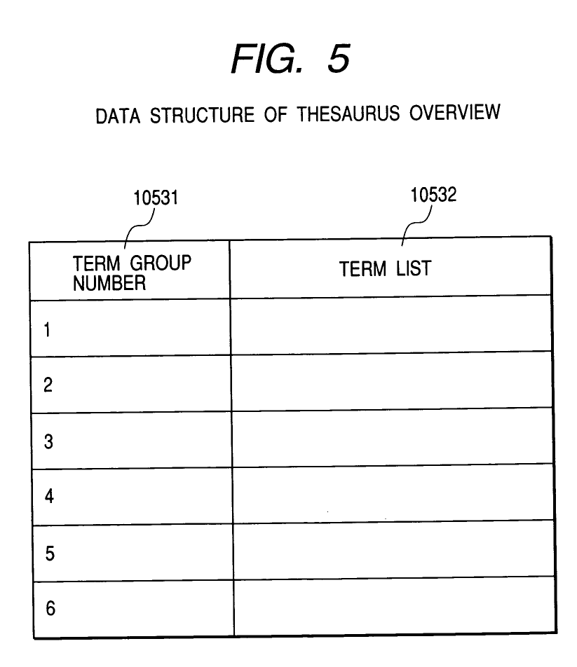

An overview of the association thesaurus in the association thesaurus storage section 1051 is stored in the thesaurus overview storage section 1053. Here, the thesaurus overview is representative terms extracted as the most characteristic terms within the document collection, and representative terms with a strong association are summarized into a term cluster. FIG. 5 shows the data structure of the thesaurus overview storage section 1053. The thesaurus overview storage section 1053 comprises a term group number 10531 and a term list 10532. A list of terms belonging to the term cluster is stored in the term list 10532.

The thesaurus browsing data has now been described.

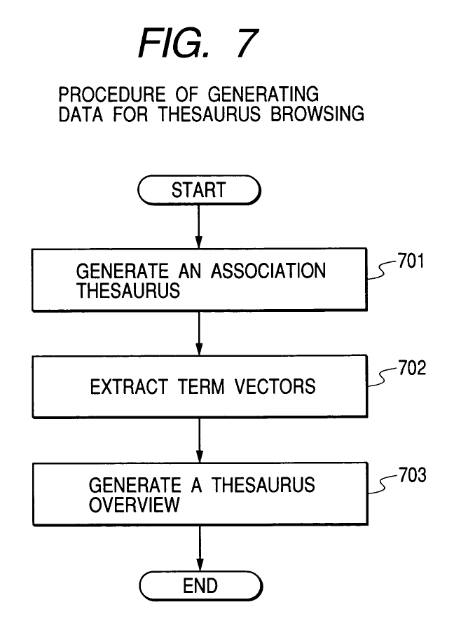

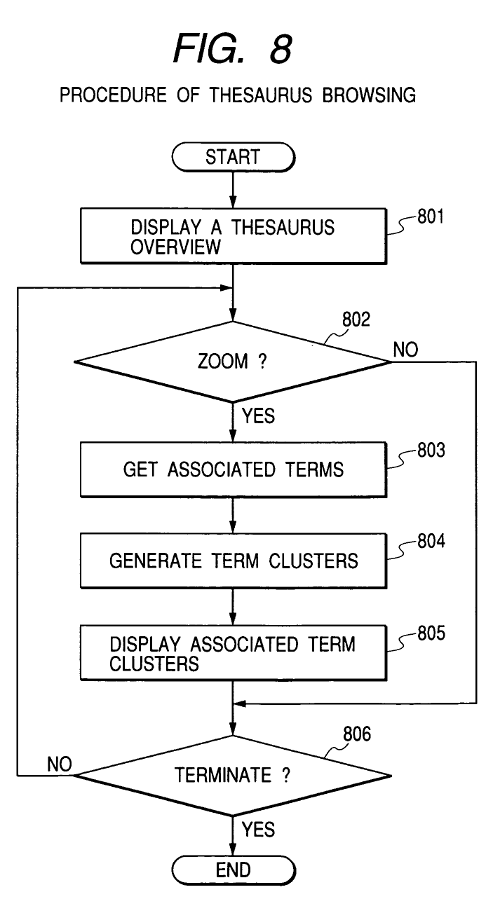

The procedures for generating thesaurus browsing data and thesaurus browsing processing for implementing the thesaurus browsing functions are described next using the flow charts in FIG. 7 and FIG. 8.

(Procedures for Generating Thesaurus Browsing Data)

Thesaurus browsing data is first of all made to prepare the analysis environment. The process for generating thesaurus browsing data, as shown in FIG. 7, comprises the steps of generating an association thesaurus (step 701) showing the term and term association level from each document; extracting term vectors from each document (step 702); and generating a thesaurus overview (step 703). The thesaurus overview extracts the most characteristic terms within the document collection representative terms, and summarizes representative terms with a strong association into a term cluster. The representative term process sets key terms made up of term vectors and important in each document, as the representative terms. The term cluster generation process summarizes terms with a high association (association level) into one cluster based on the association level between terms store in the association thesaurus.

(Thesaurus Browsing Processing Procedure)

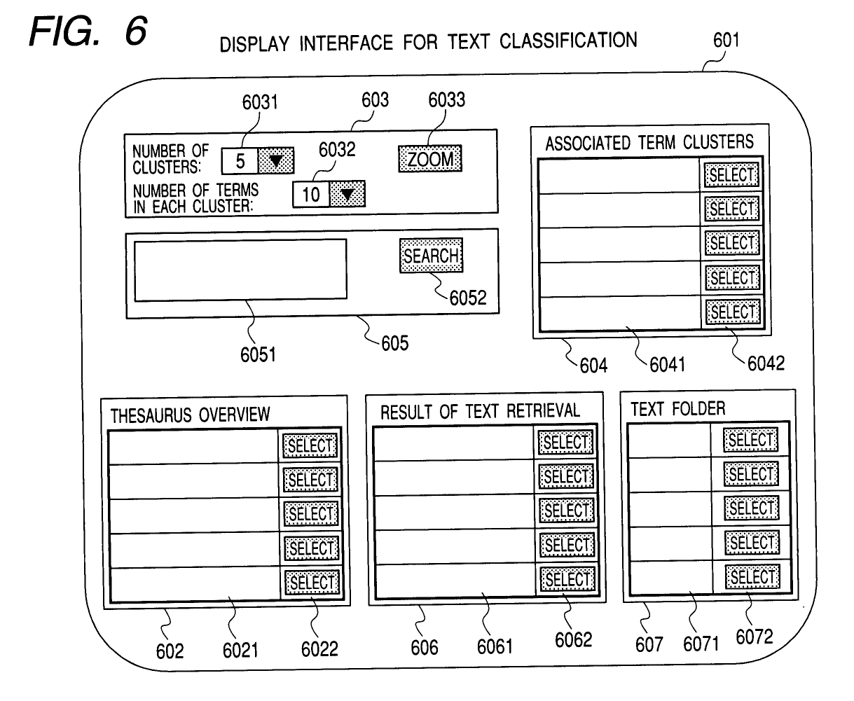

In the thesaurus browsing process as shown in FIG. 8, the thesaurus overview stored in the thesaurus overview storage section 1053 is for example displayed to the user as shown in thesaurus overview display 602 in FIG. 6 (step 801). The thesaurus overview display 602 comprises a term list display 6021 and a select button 6022. The term list 10532 stored in the thesaurus overview storage section 1053 is displayed on the term list display 6021. If the user next selects the term cluster list 6021 using for example, a select button as an input unit 6022, and commands zoom with the zoom button 6033 (step 802), the user then acquires associated terms of terms belonging to the term cluster on the association thesaurus 1051 (step 803). These terms are set as a clustering (step 804) and the generated term clusters are displayed on the association term cluster display 604 (step 805). If the user commands the termination of thesaurus browsing (step 806), then the processing ends, and if there is no command from the user then the process returns to step 802. During the zooming command in step 802, if the user selects the term cluster 6041 displayed on association term cluster display 604 by using the select button 6042 and commands zooming with the zoom button 6033, then words associated with that association term cluster are displayed on the association term cluster display 604. If the user clicks on a term displayed on the thesaurus overview display 602 or association term cluster display 604 and then clicks the zoom button 6033, then words associated with each term are displayed on the association term cluster display 604. The user can command how many clusters to separate the terms into or what terms to extract into one cluster by selecting (clicking) the Number of Clusters 6031 and the Number of Terms in each Cluster 6033.

(Benefits of Thesaurus Browsing)

A function to search for (retrieve) key words in a text and a function to store text in a folder allows the user to extract terms associated with words the user entered as key words and store them for creating FAQ. Also, a thesaurus can be created from the overall text database (text or transcript reply log), and a thesaurus browsing function provided allowing the user to navigate to a portion of the thesaurus containing terms the user selected after checking a thesaurus overview showing the overall thesaurus structure, thus making it easy for the user to hit upon (conceive) key words. Checking the thesaurus overview makes it easy for the user to acquire a grasp of topics within the document collection. Viewing the array of representative terms summarized into one term cluster allows perceiving the topic and its contents. Setting terms associated with a term on the cluster display (display summarizing terms with a strong correlation as term clusters) assists in conjecturing on the topics, sub-topics and their contents linked to that term.

The system of the present invention contains a thesaurus browsing function and key word text retrieval function allowing the user to extract text containing high frequency information and store it in a classification folder and further contains another function to collect the remaining text into a low frequency information folder. FIG. 6 shows the layout of the display interface for text classification (or text classification display). The text classification display 601 as shown in FIG. 6, comprises a thesaurus overview display 602 for thesaurus browsing, a thesaurus zooming function 603, an associated term cluster display 604, a text retrieval command section 605 for keyword text retrieval, a text retrieval result display 606 and a text save section 607 for saving the text category.

The thesaurus overview display 602 comprises a term list display 6021 and a Select button 6022. A term list 10532 stored in the thesaurus overview storage section 1053 is displayed on the term list display 6021. The thesaurus zooming function 603 is made up of a Number of clusters 6031, a Number of terms in each cluster 6032 and a zoom button 6033.

The associated term cluster display 604 is made up of a term list display section 6041 and a select button 6042.

The text retrieval command section 605 is made up of a search term entry box 6051 and a search button 6052. The text retrieval result display 606 is made up of a text display 6061 and a text select button 6062. The text save section 607 is made up of a folder name display 6071 and a folder select button 6072.

(Text Classification Procedure)

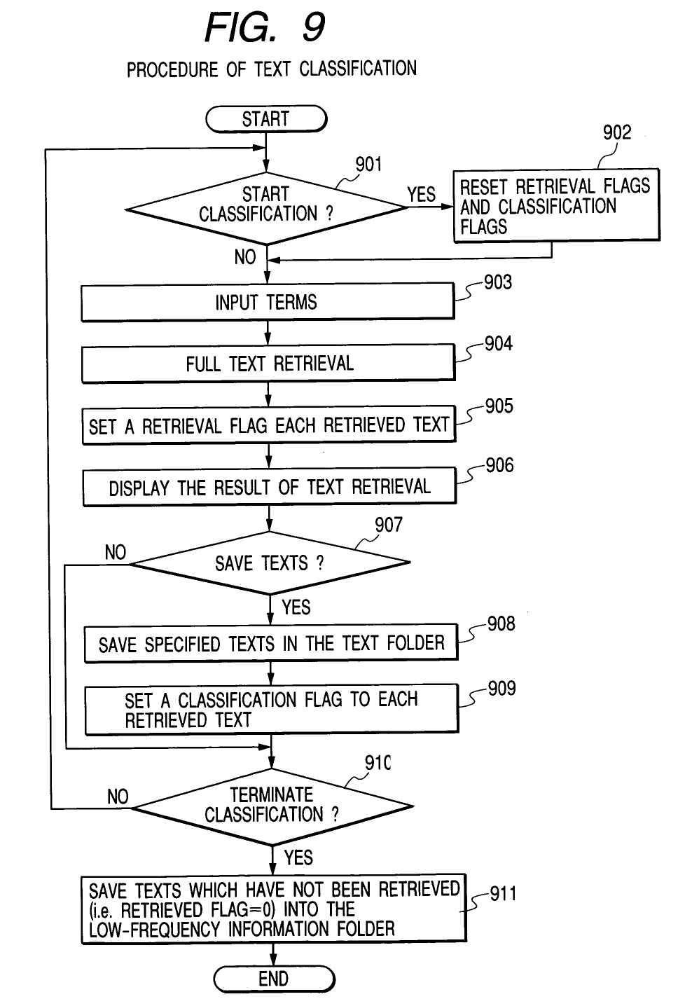

The system of the present invention contains a function to collect the remaining text information and store it in a low frequency information folder after extracting the text containing high frequency information and storing it in a folder. FIG. 9 is a flow chart showing the text classification procedure of the present system. The text classification procedure of this system is next described using the text classification screen of FIG. 6 and the flow chart of FIG. 9. When a start classification command is issued (step 901), the call center text database 104 is accessed and a retrieval flag 1043 showing retrieval is complete and a classification flag 1044 showing classification is complete are reset to “0” value. When the user enters a term into the search term entry box 6051 and clicks the search button 6052 to command key word text search (retrieval) (step 903), the transcript of conversation (reply log memo) 1042 of call center text database 104 makes a text retrieval (search) for a corresponding key word (step 904), the retrieval flag 1043 of call center text database 104 is set to “1” to show that retrieval is complete (step 905), and the text retrieval results are displayed in text display 6061 of text retrieval result display 606 (step 906). When the user wants to save a text from the text retrieval result list and clicks the text select button 6062 and folder select button 6072 (step 907), the selected text is saved in the text save folder 106 (step 908), and the classification flag 1044 in the call center text database 104 is set to “1” to show that classification is complete (step 909).

If the user commands that classification end (step 910), text with a retrieved flag of “0” is stored in the low frequency information folder (911).

The method for storing text into the low frequency information folder may also function so that text with retrieved flag of “0” is stored in the low frequency information folder. A select flag may also be prepared in the text save folder so that text other than text whose classification is specified by the user as complete, are saved in the low frequency information folder. Further, instead of a retrieved flag and a classification complete flag showing that retrieval and classification is complete, the retrieval count and classification counts may be updated and text with a value lower than a retrieval count and classification count threshold may be stored in the low frequency information folder.

The system of the present invention contains a thesaurus browsing function to assist in remembering key words. The user can make a search the text for a key word by selecting a term displayed during the thesaurus browsing process. Clicking on a term displayed in the term list display 6021 of thesaurus overview display 602 copies that term into the search term entry box 6051. Clicking the select button 6022 of thesaurus overview display 602 copies all terms displayed in the term list display 6021 into the search term entry box 6051. In the same way, clicking on a term displayed in term list display section 6041 of association term cluster display 604 copies that term into search term entry box 6051, and clicking the select button 6042 copies all terms displayed in term list display section 6041 into the search term entry box 6051. Terms appearing within the overall transcript (reply log) are linked (given associations) and stored. Thesaurus browsing therefore allows collecting and classifying high frequency information.

(Extracting Knowledge from Low Frequency Information)

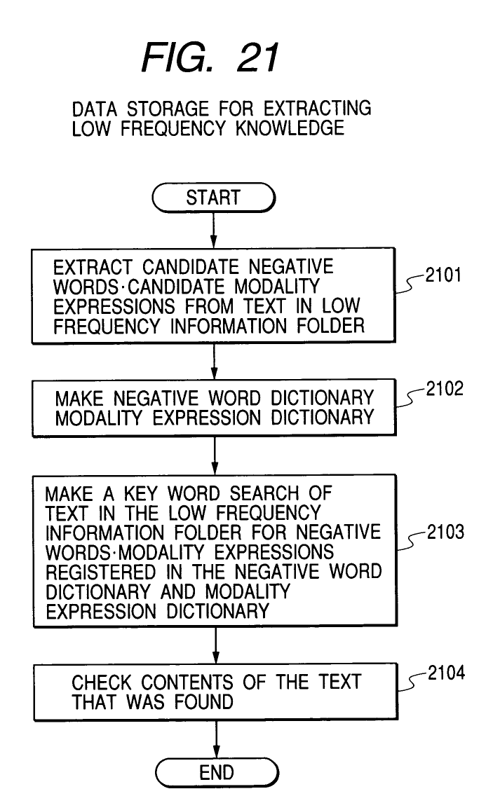

The system of the present invention can collect text never retrieved in the period from the start to finish of classifying, or text not classified into any folder, and store it in a low frequency information folder. Here, terms possessing negative meanings such as “ [symbol] (rude)” and “ [symbol] [symbol] (disappointment)”, or modality expressions such as [symbol] [symbol] [symbol] (won't you give)”, “ [symbol] (originally)”, “ [symbol] [symbol] (why can't you)”, and “ [symbol] (want)” serve as effective indicators when analyzing text for the purpose of risk management. As unit for extracting knowledge from low frequency information valuable for risk management, a function for extracting negative expressions and a function for extracting modality expression showing a customer or an operator modality are provided. An overview of the procedure for extracting text containing negative expressions and modality expressions from transcript of conversations (reply log memo) stored in low frequency information folders is described next using the flow chart in FIG. 21. First of all, candidate negative words and candidate modality expressions are extracted from the transcript of conversations (reply log memo) stored in low frequency information folders (step 2101). Selections made by the user from these candidate negative words and candidate modality expressions are next registered in the negative word dictionary and modality expression dictionary (step 2102). Finally, a key word search (or retrieval) is made using the terms registered as key words in the negative word dictionary and modality expression dictionary as the key words (step 2103), and the text containing negative words and modality expressions are extracted and the contents checked (step 2104).

The procedure for extracting negative expressions and modality expressions is described next.

(Extracting Negative Expressions)

The present system contains a unit for extracting negative expressions from the transcript of conversations (reply log memo). This unit comprises a negative word candidate extraction function for extracting negative word candidates from the transcript of conversations (reply log memo); and a negative word dictionary creation function for registering words among the candidate negative words decided by the user to be negative words. To implement these functions, the present system comprises a negative character dictionary 1071 registered with characters that tend (high probability) to comprise elements of negative words such as “ [symbol] (lose)”, “ [symbol] (negative)”, and “ [symbol] (slow)”; a negative word dictionary 1072 registered with words already determined to be negative words; and a stop word dictionary (for extracting negative words) 1073 registered with words already determined not to be negative words.

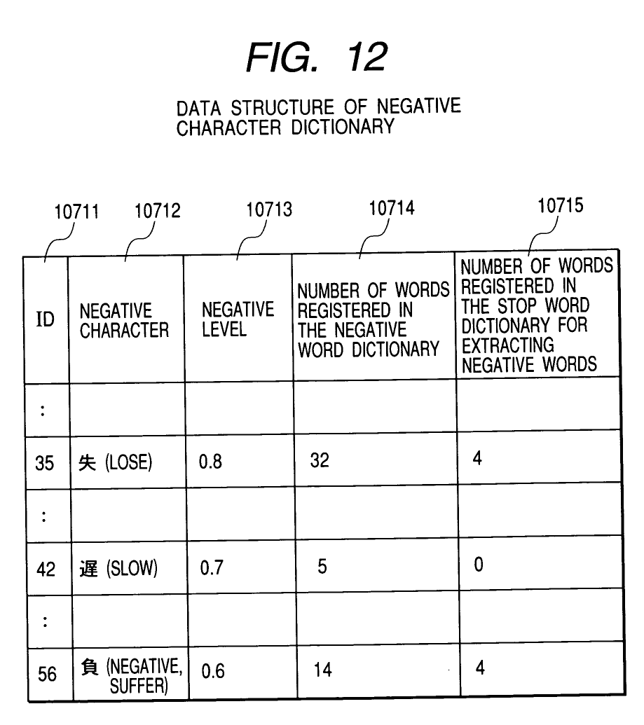

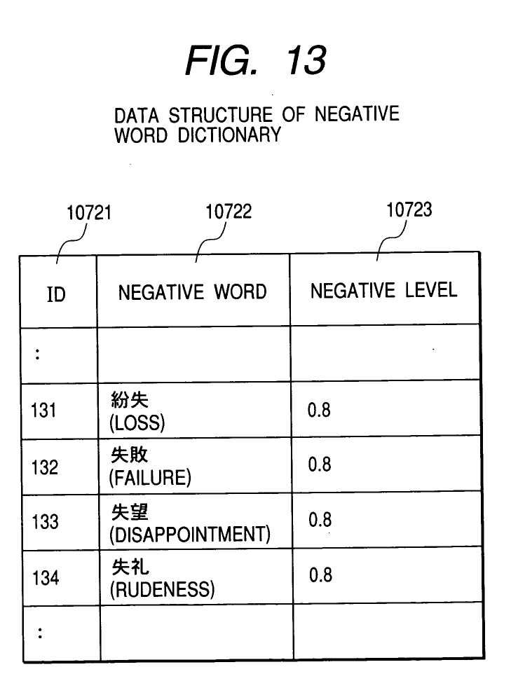

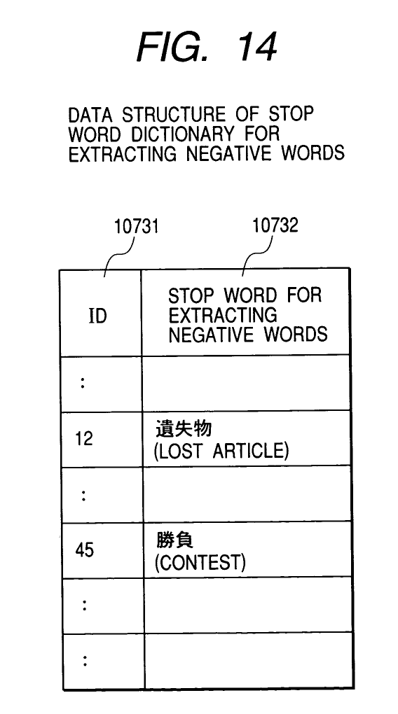

FIG. 12 shows the data structure of the negative character dictionary 1071. As shown in FIG. 12, each record of the negative character dictionary contains an ID record 10711, a Negative character 10712, a Negative level 10713, a Number of words registered in negative word dictionary 10714, and a Number of words registered in stop word dictionary (for extracting negative words) 10715. The Number of words negative word dictionary 10714 holds the number of words containing the target negative character among words registered in the negative character dictionary, the Number of words registered in stop word dictionary 10715 holds the number of characters containing the target negative word from among words registered in the dtop word dictionary 1073 (for extracting negative words), the negative level 10713 holds a value of 0 or 1 showing the percentage of words registered in the negative word dictionary from among words extracted as candidate negative words. The value of this negative level may also be set as desired by the user. FIG. 13 shows the data structure of a negative word dictionary 1072. Each record of the negative word dictionary holds a record ID 10721, a Negative word 10722, and a Negative level 10723. The Negative level 10723 holds a values for the negative level 10713 recorded in the negative character dictionary. FIG. 14 shows the data structure of the (negative) stop word dictionary (for extracting negative words) 1073. Each record in the (negative) stop word dictionary holds a record ID 10731 and a Stop word for extracting negative words 10732.

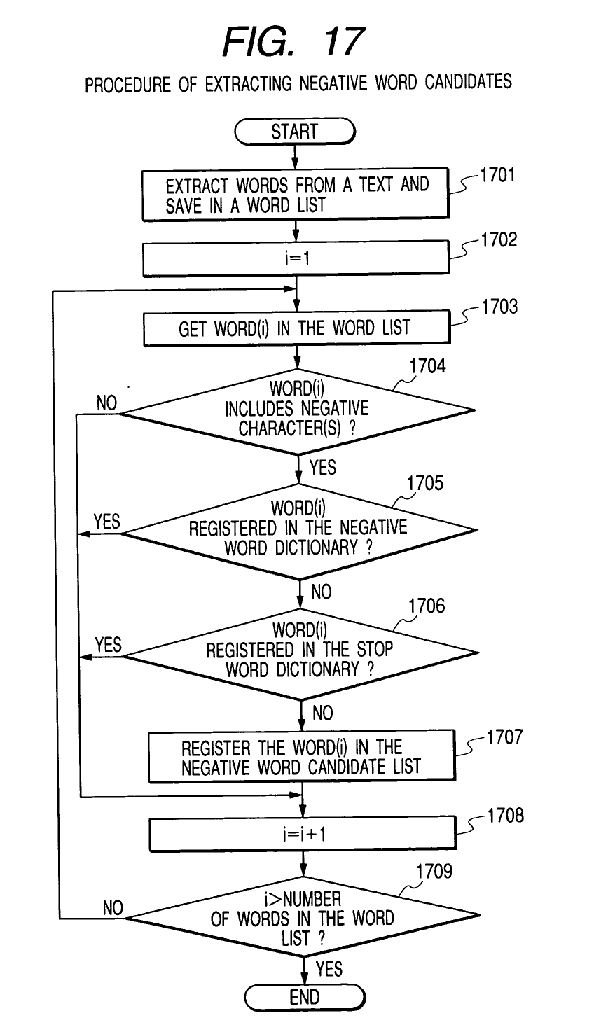

The procedure for extracting candidate negative words is described next while referring to the flow chart FIG. 17. First, all words appearing in the transcript of conversation (memo) 1042 are extracted and a word list created (step 1701). One word is loaded from the word list (step 1703) and a search made of the negative character dictionary 1071, and whether or not the word contains negative characters is decided (step 1704). If the word contains negative characters, then a search is made of the negative word dictionary 1072, and a check (decision) made if the word is already registered in the negative word dictionary 1072 (step 1075). If already registered in the negative word dictionary 1072, then it is already known to be a negative word, so the word is not extracted as a candidate negative word and processing related to this word is terminated. If the word is not registered in the negative word dictionary 1072 then a search is made of the (negative) stop word dictionary 1073, and whether or not the word is already registered in the (negative) stop word dictionary 1073 is decided (step 1706). If registered in the (negative) stop word dictionary 1073 then it is already known not to be a negative word so the word is not extracted as a candidate negative word and processing related to this word is terminated. The word is then registered in the candidate negative word list (stop 1707), if found to be not registered in the negative word dictionary and not registered in the (negative) stop word dictionary. By performing this same processing on all words registered in the word list, of those words containing negative characters, those words not registered in the negative word dictionary and those words not registered in the (negative) stop word dictionary, can be registered in the candidate negative word list.

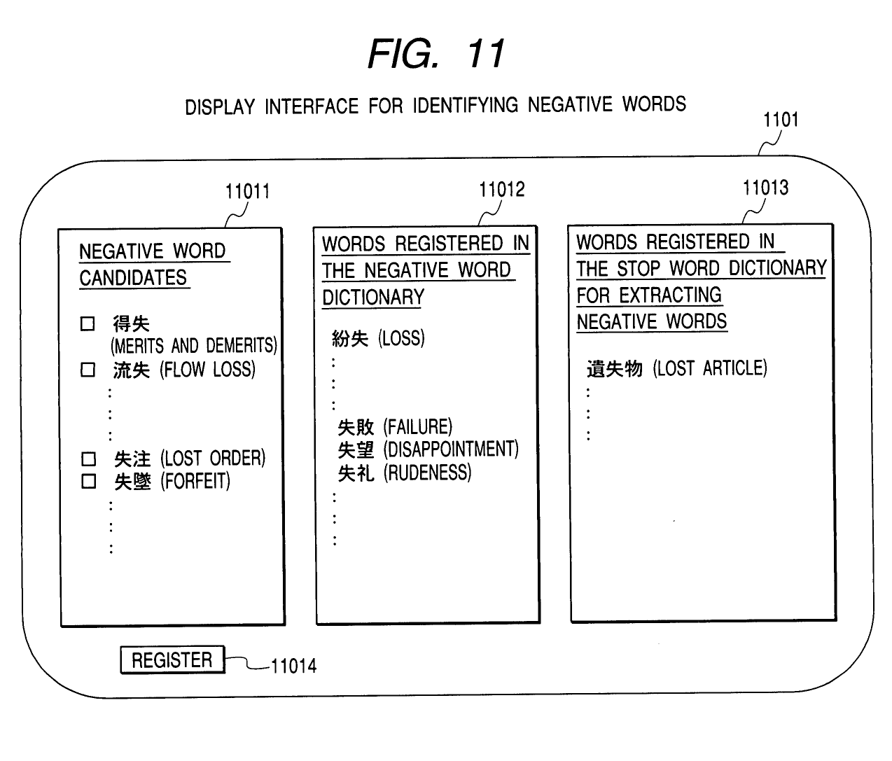

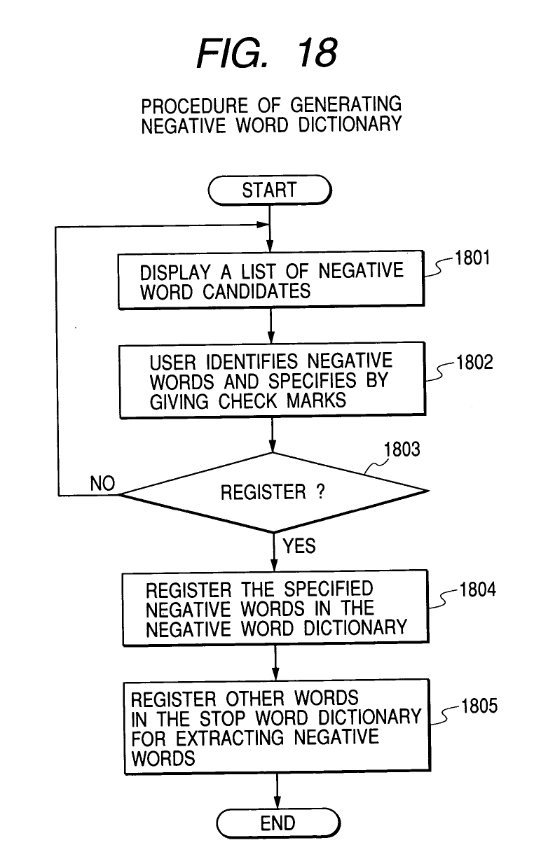

The procedure for creating the negative word dictionary is described next while referring to the flow chart of FIG. 18. First of all, to decide if the candidate negative word is a negative word or not, the candidate negative word list is displayed on the screen (step 1801). A typical negative word check screen is shown in FIG. 11. The negative word check screen contains a Candidate negative word display 11011, a Words registered in negative word dictionary display 11012, a Words registered in stop word dictionary (for extracting negative words) display 11013, and a Register button 11014. The Words registered in negative word dictionary display 11012 and Words registered in stop word dictionary (for extracting negative words) display 11013 are displayed as reference information for making a decision but may be omitted. The user decides whether or not the candidate negative word displayed in the Candidate negative word display 11011 is a negative word and enters a check mark on that word if determined to be a negative word (step 1802). When the user clicks the Register button 11014 (step 1803), the word determined to be a negative word is registered in the negative word dictionary (step 1804). When determined not to be a negative word, that word is registered in the stop word dictionary (step 1805)

(Extracting Modality Expressions)

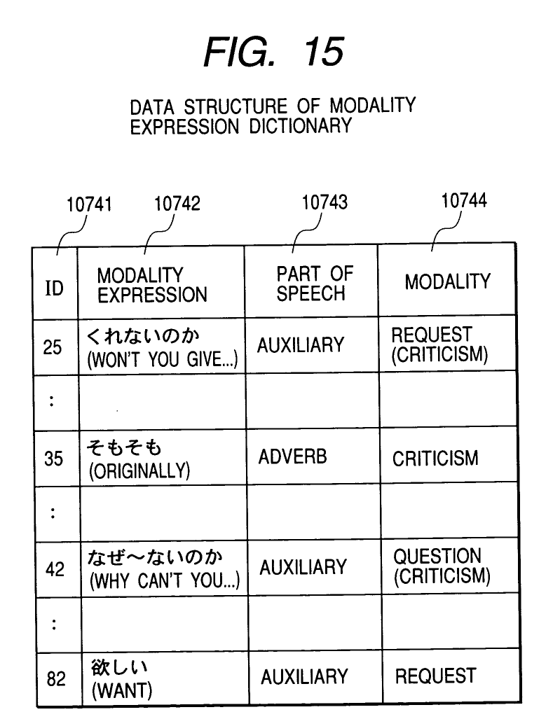

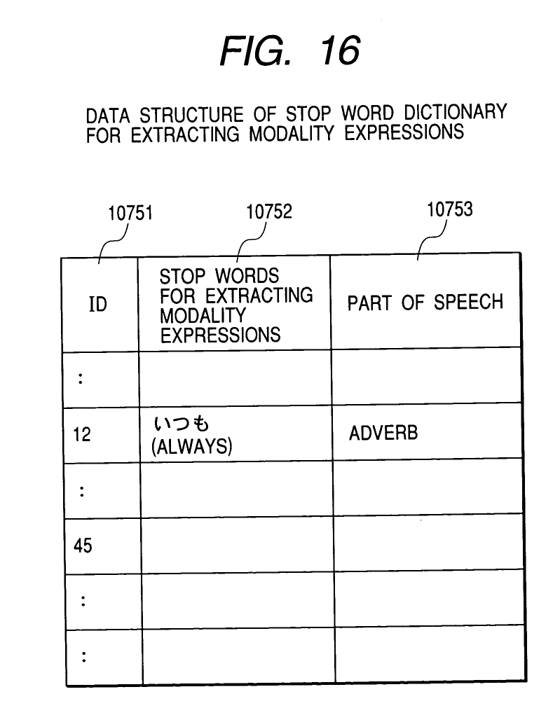

The function for extracting modality expressions showing the customer and operator modality is described next. FIG. 15 shows the data structure of the modality expression dictionary 1074. Each record in the modality expression dictionary contains a Record ID 10741, a Modality expression 10742, a Part of speech 10743, and a Modality 10744. FIG. 16 shows the data structure of the modality expression stop word dictionary 1075. Each record in the modality expression stop word dictionary contains a Record ID 10751, a Modality expression stop word 10752 and a Part of Speech 10753.

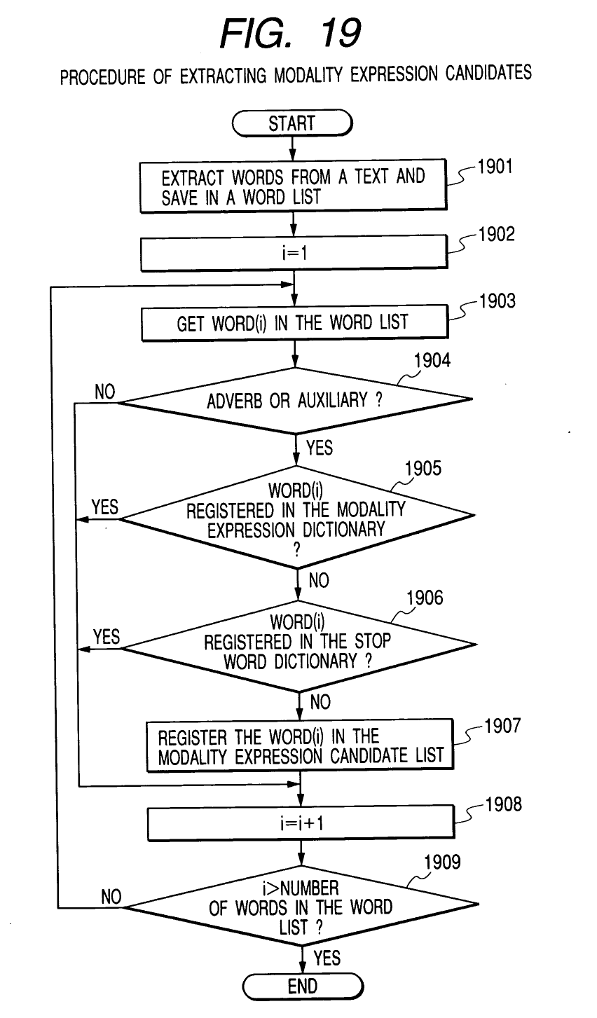

The procedure for extracting the candidate modality expression is described next while referring to the flow chart in FIG. 19. First, all words appearing in the transcript of conversation (memo) 1042 are extracted and a word list created (step 1901). One word is loaded from the word list (step 1903), and if the part of speech is a helping verb (step 1904), then the process proceeds to extracting the candidate modality expression. In other words, a search is made of the modality expression dictionary 1074 and whether or not the word is registered in modality expression dictionary 1074 is decided (step 1905). If registered in the modality expression dictionary 1074, then it is already known to be a modality expression so the word is not extracted as a candidate modality expression and processing related to that word ends. If not registered in the modality expression dictionary 1074, then a search is made of the modality expression stop word dictionary 1075, and whether or not the word is registered in the modality expression stop word dictionary 1075 is decided (step 1906). If registered in the modality expression stop word dictionary 1075 then it is already known not to be a modality expression so the word is not extracted as a candidate modality expression and processing related to that word ends. Words not registered in the modality expression dictionary and also not registered in the modality expression stop word dictionary, are then registered in the candidate modality expression list (step 1907). By performing the same processing on all words registered in the word list, those words whose part of speech is an adverb or helping verb and that are not registered in the modality expression dictionary and modality expression stop word dictionary are then registered in the candidate modality expression list.

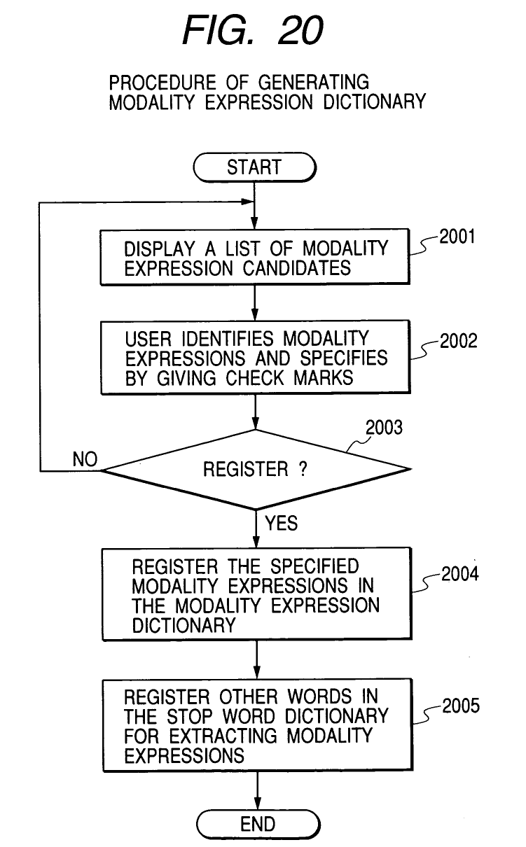

The procedure for creating the modality expression dictionary is described next while referring to the flow chart in FIG. 20. The candidate modality expression list is first of all displayed (step 2001) to determine whether or not the candidate modality expression is a modality expression. A modality expression check screen is used that is the same as the negative word check screen of FIG. 11. The user decides if the candidate modality expression displayed on the screen is a modality expression or not and places a check mark on the word decided to be modality expression (step 2002). When the user clicks the Register button (step 2003), the word decided to be a modality expression is registered in the modality expression dictionary (step 2004). Words decided not to be modality expressions are registered in the modality expression stop word dictionary (step 1805).

What is claimed is:

1. An information processor comprising:
a memory unit for storing multiple data;
an association attaching unit for attaching common associations to data possessing a common word or term among the stored data; and
an analysis unit for analyzing said data,
wherein the analysis unit analyzes data with no associations by using a negative word dictionary, and data with associations is analyzed by different analysis.

2. An information processor according to claim 1, comprising:
an input unit; and
a unit to search said database using a key word received by way of said input unit,
wherein said association attaching unit attaches the associations to the extracted retrieval result data.

3. An information processor according to claim 2, wherein said input unit receives a specified count extracted in said retrieval unit, and
said analysis unit analyzes data possessing associations extracted by a count larger than said count, and data possessing associations extracted by a count smaller than said count, by a different analysis method.

4. An information processor according to claim 1, wherein said negative dictionary comprises a first dictionary storing words in Chinese character units and a second dictionary for storing words containing said Chinese characters, and
said analysis unit searches from said data for words stored in said first and said second dictionary and from words containing Chinese characters retrieved from said first dictionary displays words not in said second dictionary on said display unit, and from among said displayed words stores specified terms in said second dictionary.

5. An information processor according to claim 2, wherein said negative dictionary comprises a first dictionary storing words in Chinese character units and a second dictionary storing words containing said Chinese characters, and
said analysis unit searches from said data for words stored in said first and said second dictionary and from words containing Chinese characters retrieved from said first dictionary displays words not in said second dictionary on said display unit, and from among said displayed terms stores specified words in said second dictionary.

6. An information processor according to claim 3, wherein said negative dictionary comprises a first dictionary storing words in Chinese character units and a second dictionary storing words containing said Chinese characters, and
said analysis unit searches from said data for words stored in said first and said second dictionary and from words containing Chinese characters retrieved from said first dictionary displays words not in said second dictionary on said display unit, and from among said displayed words stores specified words in said second dictionary.

7. An information processor according to claim 1, further comprising a dictionary for storing words expressing modalities, wherein said analysis unit performs analysis using said dictionary.

8. An information processor according to claim 2, further comprising a dictionary for storing words expressing modalities, wherein said analysis unit performs analysis using said dictionary.

9. An information processor according to claim 2, comprising:
a unit to calculate the association level between a word and a word from said stored data;
a unit for extracting key terms from said stored data;
a unit for clustering said key term using said information association level and generating a thesaurus overview; and
a display unit for displaying said generated thesaurus overview,
wherein said display unit displays key terms belonging to clusters of the thesaurus overview selected by said input unit, and
key terms specified by said command input unit from said displayed key terms are set as said key words.

10. An information processor comprising:
a first dictionary for storing words in Chinese character units;
a second dictionary for restoring words containing said Chinese characters;
a display unit; and
an input unit,
wherein a search unit for searching for words stored in second dictionary from data recorded in a memory unit, and said search unit searches also for words containing Chinese characters stored in said first dictionary, and displays retrieved words containing Chinese characters stored in said first dictionary on a display unit, and stores words specified from among said displayed words into said second dictionary.

11. An information processor according to claim 10 comprising a third dictionary for accumulating words that are not specified.

12. An information processor according to claim 10, wherein said first dictionary stores Chinese characters possessing a negative meaning, and
said second dictionary stores words having a negative meaning.

13. An information processor according to claim 11, wherein said first dictionary stores Chinese characters possessing a negative meaning, and
said second dictionary stores words having a negative meaning.

14. A program comprising:
a step for accepting the entry of a key word;
a step for searching multiple data stored in a memory unit containing said multiple data by using a key word;
a step for attaching a common association to the extracted results of said search; and
a step for analyzing data not attached with associations by using said negative word dictionary, and analyzing data attached with associations using data that is not said negative word dictionary.
